(19) United States
(12) Patent Application Publication
(10) Pub. No.: US 2022/0181692 A1
(43) Pub. Date: Jun. 9, 2022

(54) ELECTROLYTIC SOLUTION FOR SECONDARY BATTERY, AND SECONDARY BATTERY

(71) Applicant: MURATA MANUFACTURING CO., LTD., Kyoto (JP)

(72) Inventors: Midori SAITOU, Kyoto (JP); Takuju HASHIMOTO, Kyoto (JP)

(21) Appl. No.: 17/682,056

(22) Filed: Feb. 28, 2022

Related U.S. Application Data
(63) Continuation of application No. PCT/JP2020/031445, filed on Aug. 20, 2020.

(30) Foreign Application Priority Data
Sep. 4, 2019 (JP) 2019-161076

(51) Int. Cl. H01M 10/0567; H01M 10/0525

(52) U.S. Cl. CPC H01M 10/0567; H01M 2300/0025; H01M 10/0525

(57) ABSTRACT

A secondary battery includes a positive electrode, a negative electrode, and an electrolytic solution. The electrolytic solution includes a sulfur-phosphorus-containing compound.

### CROSS REFERENCE TO RELATED APPLICATIONS

The present application is a continuation of PCT patent application no. PCT/JP2020/031445, filed on Aug. 20, 2020, which claims priority to Japanese patent application no. JP2019-161076, filed on Sep. 4, 2019, the entire contents of which are being incorporated by reference.

The present disclosure relates to: an electrolytic solution to be included in a secondary battery; and a secondary battery including the electrolytic solution.

Various electronic apparatuses such as mobile phones have been widely used. Accordingly, a secondary battery is under development as a power source which is smaller in size and lighter in weight and allows for a higher energy density. The secondary battery includes a positive electrode, a negative electrode, and an electrolytic solution. The electrolytic solution is a liquid electrolyte. A configuration of the secondary battery influences battery characteristics, and has thus been given various considerations.

Specifically, as an additive to be added to the electrolytic solution, various compounds are used depending on purposes. First, a monofluorophosphoric acid salt is used in combination with 1,3-propenesultone in order to improve, for example, a low-temperature discharge characteristic. Second, a composite compound of a phosphoric acid ester and a carboxylic acid ester is used in order to improve high-temperature cyclability characteristic. Third, an asymmetric imide salt is used in order to improve high-temperature durability. An anion part of the imide salt has a ring structure including sulfur (S), phosphorus (P), and nitrogen (N) as elements forming a ring. A monofluorophosphoric acid ester in which an ester portion includes a carbon-carbon unsaturated bond is used in order to reduce a battery resistance of earlier cycles.

### SUMMARY

The present application relates to an electrolytic solution for a secondary battery; and a secondary battery including the electrolytic solution.

Although various considerations have been given to improve battery characteristics of a secondary battery, the battery characteristics are not sufficient yet. Accordingly, there is still room for improvement in terms of battery characteristics.

The technology has been made in view of such an issue and the technology is directed to provide, in an embodiment, an electrolytic solution for a secondary battery and a secondary battery that make it possible to achieve a superior battery characteristic.

An electrolytic solution for a secondary battery according to one embodiment of the technology includes a sulfur-phosphorus-containing compound represented by Formula (1).

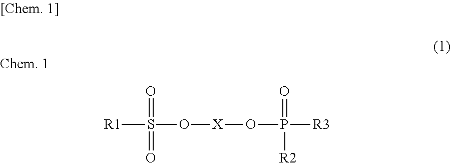

where:
each of R1, R2, and R3 is one of a monovalent hydrocarbon group, a monovalent oxygen-containing hydrocarbon group, a monovalent halogenated hydrocarbon group, a monovalent halogenated oxygen-containing hydrocarbon group, and a halogen group; and
X is one of a divalent hydrocarbon group and a divalent halogenated hydrocarbon group.

A secondary battery according to one embodiment of the technology includes a positive electrode, a negative electrode, and an electrolytic solution. The electrolytic solution has a configuration similar to a configuration of the above-described electrolytic solution for a secondary battery according to the embodiment of the technology.

Note that details of the monovalent hydrocarbon group, the monovalent oxygen-containing hydrocarbon group, the monovalent halogenated hydrocarbon group, the monovalent halogenated oxygen-containing hydrocarbon group, the halogen group, the divalent hydrocarbon group, and the divalent halogenated hydrocarbon group will each be described later.

According to the electrolytic solution for a secondary battery or the secondary battery of the embodiment of the technology, the electrolytic solution for a secondary battery (or the electrolytic solution) includes the above-described sulfur-phosphorus-containing compound. Accordingly, it is possible to achieve a superior battery characteristic according to an embodiment.

Note that effects of the technology are not necessarily limited to those described above and may include any of a series of effects described below in relation to the technology.

### BRIEF DESCRIPTION OF THE FIGURES

FIG. 1 is a perspective view of a configuration of a secondary battery (laminated-film type) according to one embodiment of the technology.

FIG. 2 is a sectional view of a configuration of a wound electrode body illustrated in FIG. 1.

FIG. 3 is a block diagram illustrating a configuration of an application example of the secondary battery (a battery pack including a single battery).

FIG. 4 is a block diagram illustrating a configuration of an application example of the secondary battery (a battery pack including an assembled battery).

FIG. 5 is a block diagram illustrating a configuration of an application example of the secondary battery (an electric vehicle).

### DETAILED DESCRIPTION

The technology is described below in further detail with reference to the drawings according to one or more embodiments.

A description is given first of a secondary battery according to an embodiment of the technology. Note that an electrolytic solution for a secondary battery (hereinafter simply referred to as “electrolytic solution”) according to an embodiment of the technology is a part (one component) of the secondary battery according to the embodiment of the technology; thus, the electrolytic solution will be described below together with the secondary battery.

The secondary battery to be described herein is a secondary battery that obtains a battery capacity using insertion and extraction of an electrode reactant, and includes a positive electrode, a negative electrode, and an electrolytic solution. To prevent precipitation of the electrode reactant on a surface of the negative electrode during charging in the secondary battery, a charge capacity of the negative electrode is greater than a discharge capacity of the positive electrode. In other words, an electrochemical capacity per unit area of the negative electrode is set to be greater than an electrochemical capacity per unit area of the positive electrode.

The electrode reactant is not limited to a particular kind, and is a light metal such as an alkali metal or an alkaline earth metal. Examples of the alkali metal include lithium, sodium, and potassium, and examples of the alkaline earth metal include beryllium, magnesium, and calcium.

Examples are given below of a case where the electrode reactant is lithium. A secondary battery that obtains a battery capacity using lithium insertion and extraction is a so-called lithium-ion secondary battery. In the lithium-ion secondary battery, lithium is inserted and extracted in an ionic state.

Here, a secondary battery of a laminated-film type will be described. The secondary battery of the laminated-film type uses, as an outer package member for containing a battery device, a film 20 having softness or flexibility.

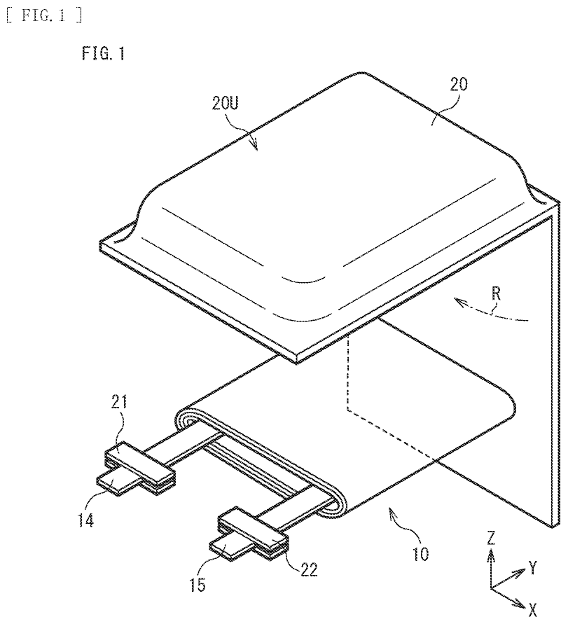

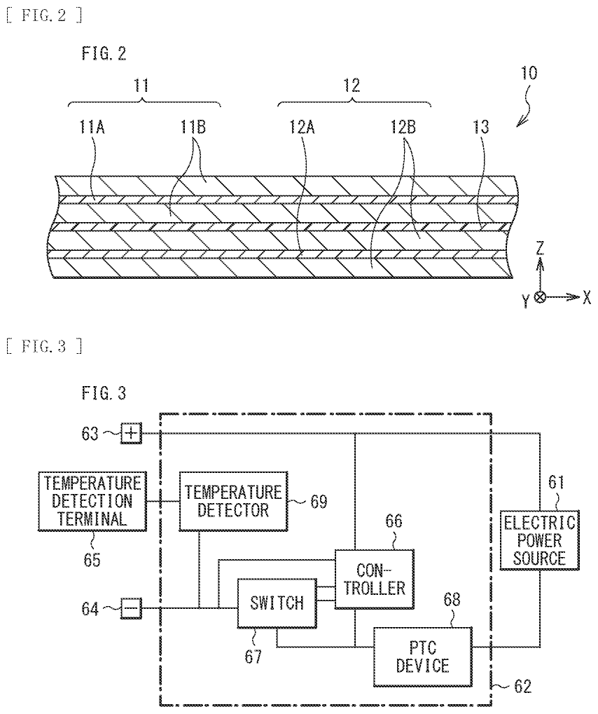

FIG. 1 is a perspective view of a configuration of the secondary battery of the laminated-film type, and FIG. 2 illustrates a sectional view of a configuration of a wound electrode body 10 illustrated in FIG. 1. Note that FIG. 1 illustrates a state in which the wound electrode body 10 and the film 20 are separated away from each other, and FIG. 2 illustrates only a portion of the wound electrode body 10.

In the secondary battery, as illustrated in FIG. 1, a wound battery device (i.e., the wound electrode body 10) is contained inside the film 20 having a pouch shape. To the wound electrode body 10, a positive electrode lead 14 and a negative electrode lead 15 are coupled. The positive electrode lead 14 and the negative electrode lead 15 are led out in respective directions that are similar to each other, from inside to outside the film 20.

The film 20 is a member having a shape of a single film, and is foldable in a direction of an arrow R (a chain line) illustrated in FIG. 1. The film 20 has a depression part 20U for containing the wound electrode body 10. The depression part 20U is a so-called deep drawn part.

Specifically, the film 20 is a three-layer laminated film including a fusion-bonding layer, a metal layer, and a surface protective layer that are stacked in this order from an inner side. In a state in which the film 20 is folded, outer edges of the fusion-bonding layer are fusion-bonded to each other. The fusion-bonding layer includes a polymer compound such as polypropylene. The metal layer includes a metal material such as aluminum. The surface protective layer includes a polymer compound such as nylon. The number of layers of the film 20 is not limited to three, and may be one, two, or four or more.

A sealing film 21 is disposed between the film 20 and the positive electrode lead 14. A sealing film 22 is disposed between the film 20 and the negative electrode lead 15. The sealing film 21 and the sealing film 22 are each a member that prevents entry of outside air, and each include a material such as a polyolefin resin. The polyolefin resin has adherence to both the positive electrode lead 14 and the negative electrode lead 15. Examples of the polyolefin resin include polyethylene, polypropylene, modified polyethylene, and modified polypropylene. Note that one or both of the sealing films 21 and 22 may be omitted.

As illustrated in FIGS. 1 and 2, the wound electrode body 10 includes a positive electrode 11, a negative electrode 12, a separator 13, and an unillustrated electrolytic solution. The electrolytic solution is a liquid electrolyte. The wound electrode body 10 has a structure in which the positive electrode 11 and the negative electrode 12 are stacked on each other with the separator 13 interposed therebetween, and the stack of the positive electrode 11, the negative electrode 12, and the separator 13 is wound. The positive electrode 11, the negative electrode 12, and the separator 13 are each impregnated with the electrolytic solution.

As illustrated in FIG. 2, the positive electrode 11 includes a positive electrode current collector 11A, and two positive electrode active material layers 11B provided on respective sides of the positive electrode current collector 11A. However, the positive electrode active material layer 11B may be provided only on one side of the positive electrode current collector 11A.

The positive electrode current collector 11A includes one or more of electrically conductive materials including, without limitation, aluminum, nickel, and stainless steel. The positive electrode active material layer 11B includes one or more of positive electrode active materials into which lithium is inserted and from which lithium is extracted. The positive electrode active material layer 11B may further include a material such as a positive electrode binder or a positive electrode conductor.

The positive electrode active material is not limited to a particular kind, and is a lithium-containing compound such as a lithium-containing transition metal compound. The lithium-containing transition metal compound includes lithium and one or more of transition metal elements, and may further include one or more of other elements. The other elements may be any elements other than a transition metal element, and are not limited to a particular kind. In particular, the other elements are preferably those belong to groups 2 to 15 in the long period periodic table of elements. Note that the lithium-containing transition metal compound may be an oxide or may be one of a phosphoric acid compound, a silicic acid compound, and a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride, polyimide, and carboxymethyl cellulose.

The positive electrode conductor includes one or more of electrically conductive materials including, without limitation, a carbon material. Examples of the carbon material include graphite, carbon black, acetylene black, and Ketjen black. The positive electrode conductor may be a material such as a metal material or an electrically conductive polymer as long as the material has an electrically conductive property.

As illustrated in FIG. 2, the negative electrode 12 includes a negative electrode current collector 12A, and two negative electrode active material layers 12B provided on respective sides of the negative electrode current collector 12A. However, the negative electrode active material layer 12B may be provided only on one side of the negative electrode current collector 12A.

The negative electrode current collector 12A includes one or more of electrically conductive materials including, without limitation, copper, aluminum, nickel, and stainless steel. The negative electrode active material layer 12B includes one or more of negative electrode active materials into which lithium is inserted and from which lithium is extracted. The negative electrode active material layer 12B may further include a material such as a negative electrode binder or a negative electrode conductor. Details of the negative electrode binder and the negative electrode conductor are similar to details of the positive electrode binder and the positive electrode conductor, respectively.

The negative electrode active material is not limited to a particular kind, and examples thereof include a carbon material and a metal-based material. Examples of the carbon material include graphitizable carbon, non-graphitizable carbon, and graphite. Examples of the graphite include natural graphite and artificial graphite. The metal-based material is a material including one or more of metal elements and metalloid elements that are each able to form an alloy with lithium. Examples of the metal element and the metalloid element include silicon and tin. The metal-based material may be, for example, a simple substance, an alloy, a compound, or a mixture of two or more thereof.

Specific examples of the metal-based material include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≤2 or 0.2<v<1.4), LiSiO, SnO_{w} (0<w≤2), SnSiO₃, LiSnO, and Mg₂Sn.

A method of forming the negative electrode active material layer 12B is not particularly limited, and includes one or more of methods including, without limitation, a coating method, a vapor-phase method, a liquid-phase method, a thermal spraying method, and a firing (sintering) method.

As illustrated in FIG. 2, the separator 13 is interposed between the positive electrode 11 and the negative electrode 12. The separator 13 is an insulating porous film that allows lithium to pass therethrough while preventing short circuiting due to contact between the positive electrode 11 and the negative electrode 12. The separator 13 may be a single-layer film including one porous film, or may be a multi-layer film including one or more porous films that are stacked on each other. The porous film includes one or more of polymer compounds including, without limitation, polytetrafluoroethylene, polypropylene, and polyethylene.

The electrolytic solution includes one or more of sulfur-phosphorus-containing compounds each represented by Formula (1). The sulfur-phosphorus-containing compound is a compound in which two functional groups are bonded to one central group (X). The two functional groups are: a sulfuric-acid-type group (R1-S(═O)₂—O—) including sulfur (S) as a constituent element; and a phosphoric-acid-type group (R3-P(═O)(—R2)-O—) including phosphorus (P) as a constituent element.

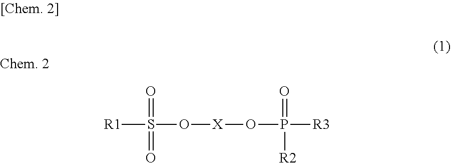

where:
each of R1, R2, and R3 is one of a monovalent hydrocarbon group, a monovalent oxygen-containing hydrocarbon group, a monovalent halogenated hydrocarbon group, a monovalent halogenated oxygen-containing hydrocarbon group, and a halogen group; and
X is one of a divalent hydrocarbon group and a divalent halogenated hydrocarbon group.

A reason why the electrolytic solution includes the sulfur-phosphorus-containing compound is that, for example, upon charging and discharging of the secondary battery, a decomposition reaction of the electrolytic solution is suppressed while an increase in an electric resistance is suppressed. Details of the reason why the electrolytic solution includes the sulfur-phosphorus-containing compound will be described later.

Details of a configuration of the sulfur-phosphorus-containing compound are as described below.

R1 is not particularly limited as long as R1 is one of the monovalent hydrocarbon group, the monovalent oxygen-containing hydrocarbon group, the monovalent halogenated hydrocarbon group, the monovalent halogenated oxygen-containing hydrocarbon group, and the halogen group, as described above.

The monovalent hydrocarbon group is a monovalent group including carbon (C) and hydrogen (H), and may have: a straight-chain structure; a branched structure having one or more side chains; a cyclic structure; or a structure in which two or more thereof are bonded to each other. The monovalent hydrocarbon group may have one or more carbon-carbon unsaturated bonds, or may include no carbon-carbon unsaturated bond. The carbon-carbon unsaturated bond is a carbon-carbon double bond (>C═C<) or a carbon-carbon triple bond (—C≡C—).

Specific examples of the monovalent hydrocarbon group include an alkyl group, an alkenyl group, an alkynyl group, a cycloalkyl group, an aryl group, and a bonded group. The bonded group related to the monovalent hydrocarbon group is a monovalent group including two or more of the alkyl group, the alkenyl group, the alkynyl group, the cycloalkyl group, and the aryl group that are bonded to each other.

The alkyl group is not limited to a particular kind, and examples thereof include a methyl group, an ethyl group, and a propyl group. The alkenyl group is not limited to a particular kind, and examples thereof include an ethenyl group, a propenyl group, and a butenyl group. The alkynyl group is not limited to a particular kind, and examples thereof include an ethynyl group, a propynyl group, and a butynyl group. The cycloalkyl group is not limited to a particular kind, and examples thereof include a cyclopropyl group, a cyclobutyl group, and a cyclohexyl group. The aryl group is not limited to a particular kind, and examples thereof include a phenyl group and a naphthyl group. The bonded group is not limited to a particular kind, and examples thereof include a benzyl group.

The alkyl group has carbon number from 1 to 4 both inclusive, although the carbon number of the alkyl group is not particularly limited. The alkenyl group and the alkynyl group each have carbon number from 2 to 4 both inclusive, although the carbon number of each of the alkenyl group and the alkynyl group is not particularly limited. The cycloalkyl group has carbon number from 3 to 6 both inclusive, although the carbon number of the cycloalkyl group is not particularly limited. The aryl group has carbon number from 6 to 14 both inclusive, although the carbon number of aryl group is not particularly limited. A reason for this is that, for example, solubility and compatibility of the sulfur-phosphorus-containing compound improve.

The monovalent oxygen-containing hydrocarbon group is a group in which one or more ether bonds (—O—) are introduced into the monovalent hydrocarbon group.

Specific examples of the monovalent oxygen-containing hydrocarbon group include: a group (an alkoxy group) in which the ether bond is introduced to an end of the monovalent hydrocarbon group; a group (an ether-type group) in which the ether bond is introduced in a middle of the monovalent hydrocarbon group; and a bonded group. The bonded group related to the monovalent oxygen-containing hydrocarbon group is a monovalent group including the alkoxy group and the ether-type group that are bonded to each other.

Here, using as an example a case where the monovalent hydrocarbon group is the ethyl group (CH₃—CH₂—) and where the number of introduced ether bonds is one: the case where the ether bond is introduced to the end (the alkoxy group) means CH₃—CH₂—O—; and the case where the ether bond is introduced in the middle (the ether-type group) means CH₃—O—CH₂—.

The alkoxy group is not limited to a particular kind, and examples thereof include a methoxy group, an ethoxy group, and a propoxy group. The ether-type group is not limited to a particular kind, and examples thereof include an ether type ethyl group (CH₃—O—CH₂) and an ether type propyl group (CH₃—O—CH₂—O—CH₂, CH₃—O—CH₂—CH₂, or CH₃—CH₂—O—CH₂).

The alkoxy group and the ether-type group each have carbon number that is similar to the carbon number of the alkyl group described above, although the carbon number of each of the alkoxy group and the ether-type group is not particularly limited. A reason for this is that, for example, the solubility and the compatibility of the sulfur-phosphorus-containing compound improve.

The monovalent halogenated hydrocarbon group is a group in which one or more hydrogen groups (—H) of the monovalent hydrocarbon group are each substituted with a halogen group. Examples of the halogen group include a fluorine group (—F), a chlorine group (—Cl), a bromine group (—Br), and an iodine group (—I). Note that only one halogen group may be included in the monovalent halogenated hydrocarbon group, or two or more halogen groups may be included in the monovalent halogenated hydrocarbon group.

Specific examples of the monovalent halogenated hydrocarbon group include a perfluoroalkyl group, a perfluoroalkenyl group, a perfluoroalkynyl group, a perfluorocycloalkyl group, a perfluoroaryl group, and a perfluorobonded group obtained by substituting each of the hydrogen groups of the alkyl group, the alkenyl group, the alkynyl group, the cycloalkyl group, the aryl group, and the bonded group with the fluorine group, respectively.

The monovalent halogenated oxygen-containing hydrocarbon group is a group in which one or more hydrogen groups of the monovalent oxygen-containing hydrocarbon group are each substituted with the halogen group, and details of the kind of the halogen group are as described above.

Specific examples of the monovalent halogenated oxygen-containing hydrocarbon group include a perfluoroalkoxy group, a perfluoroether-type group, and a perfluorobonded group obtained by substituting each of the hydrogen groups of the alkoxy group, the ether-type group, and the bonded group with the fluorine group, respectively.

Examples of the halogen group include, as described above, the fluorine group, the chlorine group, the bromine group, and the iodine group.

In particular, it is preferable that the monovalent hydrocarbon group be the alkyl group, and that the monovalent oxygen-containing hydrocarbon group be the alkoxy group. A reason for this, for example, is that the decomposition reaction of the electrolytic solution is also stably suppressed while the increase in the electric resistance is stably suppressed.

Note that details of each of R2 and R3 are similar to the details of R1 described above. However, a kind of R1 may be the same as a kind R2 or may be different from the kind of R2. Similarly, the respective kinds of R1 and R3 may be the same as or different from each other, and the respective kinds of R2 and R3 may also be the same as or different from each other.

X is not particularly limited as long as X is one of the divalent hydrocarbon group and the divalent halogenated hydrocarbon group, as described above.

Details of the divalent hydrocarbon group are similar to those of the monovalent hydrocarbon group, except that the divalent hydrocarbon group is divalent and is not monovalent. Specific examples of the divalent hydrocarbon group include an alkylene group, an alkenylene group, an alkynylene group, a cycloalkylene group, an arylene group, and a bonded group. The bonded group related to the divalent hydrocarbon group is a divalent group including two or more of the alkylene group, the alkenylene group, the alkynylene group, the cycloalkylene group, and the arylene group that are bonded to each other.

The alkylene group is not limited to a particular kind, and examples thereof include a methylene group, an ethylene group, and a propylene group. The alkenylene group is not limited to a particular kind, and examples thereof include an ethenylene group, a propenylene group, and a butenylene group. The alkynylene group is not limited to a particular kind, and examples thereof include an ethynylene group, a propynylene group, and a butynylene group. The cycloalkylene group is not limited to a particular kind, and examples thereof include a cyclopropylene group, a cyclobutylene group, and a cyclohexylene group. The arylene group is not limited to a particular kind, and examples thereof include a phenylene group and a naphthylene group. The bonded group is not limited to a particular kind, and examples thereof include a group in which one hydrogen group is eliminated from the benzyl group.

The alkylene group has carbon number from 1 to 4 both inclusive, although the carbon number of the alkylene group is not particularly limited. The alkenylene group and the alkynylene group each have carbon number from 2 to 4 both inclusive, although the carbon number of each of the alkenylene group and the alkynylene group is not particularly limited. The cycloalkylene group has carbon number from 3 to 6 both inclusive, although the carbon number of the cycloalkylene group is not particularly limited. The arylene group has carbon number from 6 to 14 both inclusive, although the carbon number of the arylene group is not particularly limited. A reason for this is that, for example, the solubility and the compatibility of the sulfur-phosphorus-containing compound improve.

The divalent halogenated hydrocarbon group is a group in which one or more hydrogen groups of the divalent hydrocarbon group are each substituted with the halogen group, and details of the halogen group are as described above. Specific examples of the divalent halogenated hydrocarbon group include a perfluoroalkylene group, a perfluoroalkenylene group, a perfluoroalkynylene group, a perfluorocycloalkylene group, a perfluoroarylene group, and a perfluorobonded group obtained by substituting each of the hydrogen groups of the alkylene group, the alkenylene group, the alkynylene group, the cycloalkylene group, the arylene group, and the bonded group with the fluorine group, respectively.

In particular, it is preferable that X be the alkylene group. A reason for this is that, for example, the decomposition reaction of the electrolytic solution is also stably suppressed while the increase in the electric resistance is stably suppressed.

In this case, the carbon number of the alkylene group is not particularly limited; however, in particular, it is preferable that the alkylene group have carbon number from 1 to 3 both inclusive. A reason for this is that, for example, the solubility and the compatibility of the sulfur-phosphorus-containing compound further improve, which allows a film derived from the sulfur-phosphorus-containing compound to be described later to be easily formed. Further, it is more preferable that the alkylene group have carbon number of 2 or 3. A reason for this is that, for example, the solubility and the compatibility of the sulfur-phosphorus-containing compound still further improve, which allows the film to be more easily formed.

The sulfur-phosphorus-containing compound is not limited to a particular kind as long as the sulfur-phosphorus-containing compound is a compound satisfying a condition represented by Formula (1). Specific examples of the sulfur-phosphorus-containing compound include respective compounds represented by Formulae (1-1) to (1-28).

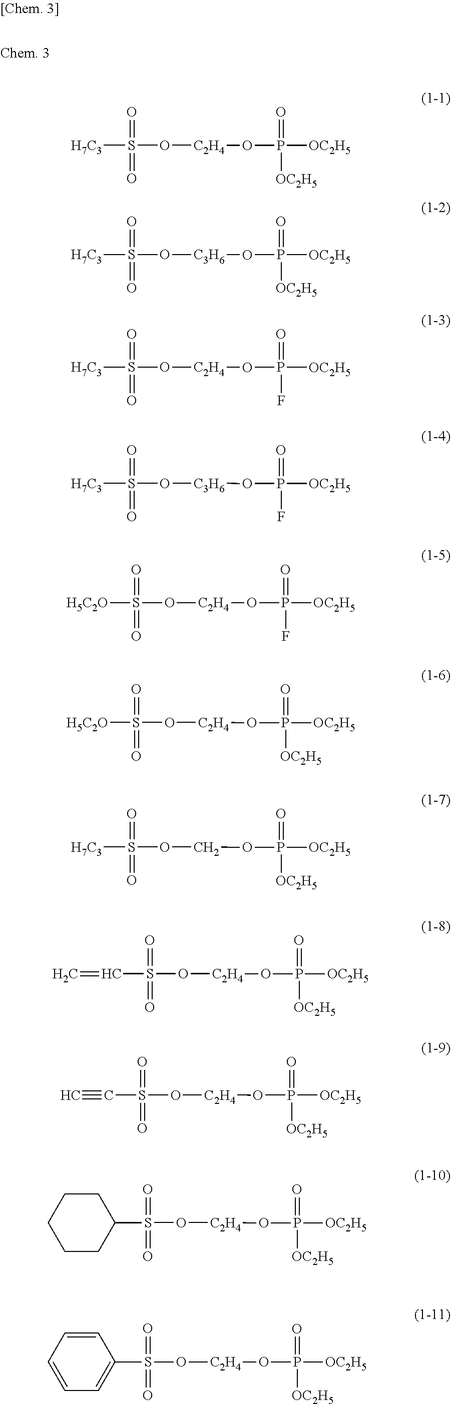

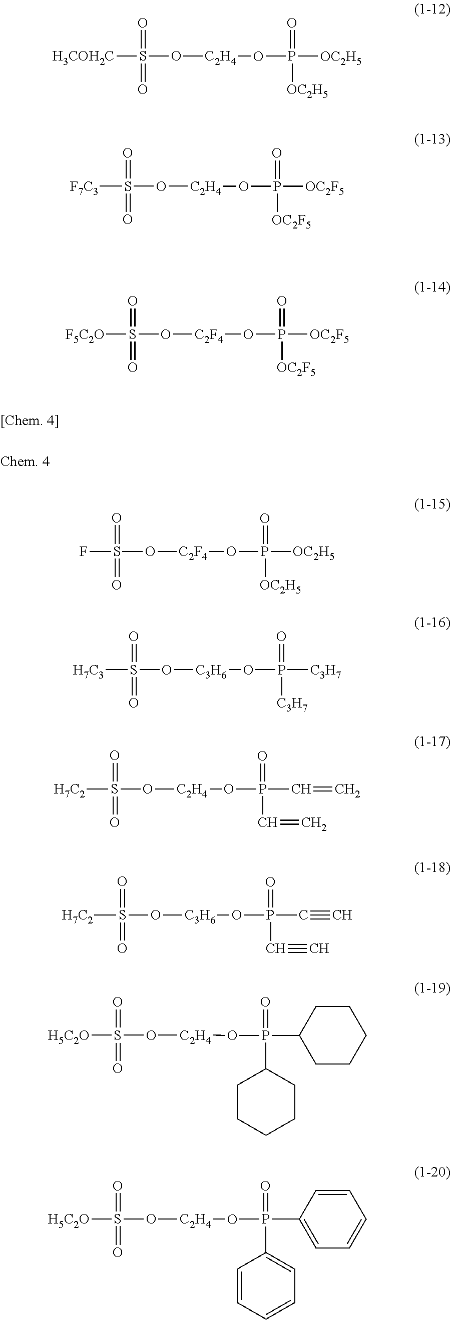

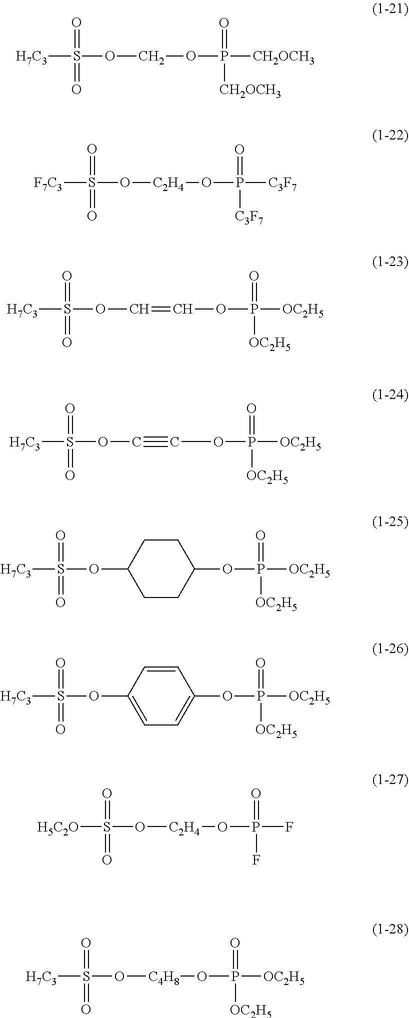

A content of the sulfur-phosphorus-containing compound in the electrolytic solution is not particularly limited; however, in particular, the content is preferably from 0.01 wt % to 1 wt % both inclusive. A reason for this is that, for example, the decomposition reaction of the electrolytic solution is sufficiently suppressed while the increase in the electric resistance is sufficiently suppressed. Note that the content of the sulfur-phosphorus-containing compound described here is a value after a stabilization process of the secondary battery to be described later is performed, that is, after a solid electrolyte interphase (SEI) film is formed.

The electrolytic solution may further include a solvent and an electrolyte salt. Only one solvent may be used, or two or more solvents may be used. Also, only one electrolyte salt may be used, or two or more electrolyte salts may be used. Note that the sulfur-phosphorus-containing compound described above is excluded from the solvent to be described here.

The solvent includes a non-aqueous solvent (an organic solvent), and the electrolytic solution including the non-aqueous solvent is a so-called non-aqueous electrolytic solution. Examples of the non-aqueous solvent include esters and ethers. Specific examples thereof include a carbonic-acid-ester-based compound, a carboxylic-acid-ester-based compound, and a lactone-based compound.

Examples of the carbonic-acid-ester-based compound include a cyclic carbonic acid ester and a chain carbonic acid ester. Examples of the cyclic carbonic acid ester include ethylene carbonate and propylene carbonate. Examples of the chain carbonic acid ester include dimethyl carbonate, diethyl carbonate, and methyl ethyl carbonate. Examples of the carboxylic-acid-ester-based compound include methyl acetate, ethyl acetate, methyl propionate, ethyl propionate, propyl propionate, and ethyl trimethyl acetate. Examples of the lactone-based compound include γ-butyrolactone and γ-valerolactone. Examples of the ethers other than the lactone-based compounds described above include 1,2-dimethoxyethane, tetrahydrofuran, 1,3-dioxolane, and 1,4-dioxane.

Examples of the non-aqueous solvent further include an unsaturated cyclic carbonic acid ester, a halogenated carbonic acid ester, a sulfonic acid ester, a phosphoric acid ester, an acid anhydride, a nitrile compound, and an isocyanate compound. A reason for this is that, for example, chemical stability of the electrolytic solution improves.

Specific examples of the unsaturated cyclic carbonic acid ester include vinylene carbonate (1,3-dioxol-2-one), vinylethylene carbonate (4-vinyl-1,3-dioxolane-2-one), and methylene ethylene carbonate (4-methylene-1,3-dioxolane-2-one). Examples of the halogenated carbonic acid ester include fluoroethylene carbonate (4-fluoro-1,3-dioxolane-2-one) and difluoroethylene carbonate (4,5-difluoro-1,3-dioxolane-2-one). Examples of the sulfonic acid ester include 1,3-propane sultone. Examples of the phosphoric acid ester include trimethyl phosphate and triethyl phosphate. Examples of the acid anhydride include a cyclic carboxylic acid anhydride, a cyclic disulfonic acid anhydride, and a cyclic carboxylic acid sulfonic acid anhydride. Examples of the cyclic carboxylic acid anhydride include succinic anhydride, glutaric anhydride, and maleic anhydride. Examples of the cyclic disulfonic acid anhydride include ethane disulfonic anhydride and propane disulfonic anhydride. Examples of the cyclic carboxylic acid sulfonic acid anhydride include sulfobenzoic anhydride, sulfopropionic anhydride, and sulfobutyric anhydride. Examples of the nitrile compound include acetonitrile, succinonitrile, and adiponitrile. Examples of the isocyanate compound include hexamethylene diisocyanate.

The electrolyte salt includes a light metal salt such as a lithium salt. Examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), and lithium bis(oxalato)borate (LiB(C₂O₄)₂). A content of the electrolyte salt is not particularly limited; however, the content is from 0.3 mol/kg to 3.0 mol/kg both inclusive with respect to the solvent. A reason for this is that, for example, a high ion conductivity is obtainable.

The positive electrode lead 14 is coupled to the positive electrode 11 (the positive electrode current collector 11A), and the negative electrode lead 15 is coupled to the negative electrode 12 (the negative electrode current collector 12A). The positive electrode lead 14 includes one or more of electrically conductive materials including, without limitation, aluminum, and the negative electrode lead 15 includes one or more of electrically conductive materials including, without limitation, copper, nickel, and stainless steel. The positive electrode lead 14 and the negative electrode lead 15 each have a shape such as a thin plate shape or a meshed shape.

Upon charging the secondary battery, lithium is extracted from the positive electrode 11, and the extracted lithium is inserted into the negative electrode 12 via the electrolytic solution. Upon discharging the secondary battery, lithium is extracted from the negative electrode 12, and the extracted lithium is inserted into the positive electrode 11 via the electrolytic solution. Upon charging and discharging the secondary battery, lithium is inserted and extracted in an ionic state.

In a case of manufacturing the secondary battery, the positive electrode 11 and the negative electrode 12 are each fabricated and the electrolytic solution is prepared, following which the secondary battery is assembled using the positive electrode 11, the negative electrode 12, and the electrolytic solution, according to a procedure to be described below.

First, the positive electrode active material is mixed with, on an as-needed basis, a material such as the positive electrode binder or the positive electrode conductor to thereby obtain a positive electrode mixture. Thereafter, the positive electrode mixture is put, for example, into an organic solvent to thereby prepare a paste positive electrode mixture slurry. Lastly, the positive electrode mixture slurry is applied on both sides of the positive electrode current collector 11A to thereby form the positive electrode active material layers 11B. Thereafter, the positive electrode active material layers 11B may be compression-molded by means of a machine such as a roll pressing machine. In this case, the positive electrode active material layers 11B may be heated. The positive electrode active material layers 11B may be compression-molded multiple times. The positive electrode active material layer 11B is thus formed on each of both sides of the positive electrode current collector 11A. In this manner, the positive electrode 11 is fabricated.

The negative electrode active material layers 12B are formed on both sides of the negative electrode current collector 12A by a procedure similar to the fabrication procedure of the positive electrode 11 described above. Specifically, the negative electrode active material is mixed with, on an as-needed basis, a material such as the negative electrode binder or the negative electrode conductor to thereby obtain a negative electrode mixture. Thereafter, the negative electrode mixture is put, for example, into an organic solvent to thereby prepare a paste negative electrode mixture slurry. Thereafter, the negative electrode mixture slurry is applied on both sides of the negative electrode current collector 12A to thereby form the negative electrode active material layers 12B. Thereafter, the negative electrode active material layers 12B may be compression-molded. The negative electrode active material layer 12B is thus formed on each of both sides of the negative electrode current collector 12A. In this manner, the negative electrode 12 is fabricated.

The electrolyte salt is put into the solvent, following which the sulfur-phosphorus-containing compound is added to the solvent. This allows each of the electrolyte salt and the sulfur-phosphorus-containing compound to be dispersed or dissolved into the solvent. Thus, the electrolytic solution is prepared.

First, the positive electrode lead 14 is coupled to the positive electrode 11 (the positive electrode current collector 11A) by a method such as a welding method, and the negative electrode lead 15 is coupled to the negative electrode 12 (the negative electrode current collector 12A) by a method such as a welding method. Thereafter, the positive electrode 11 and the negative electrode 12 are stacked on each other with the separator 13 interposed therebetween, following which the stack of the positive electrode 11, the negative electrode 12, and the separator 13 are wound to thereby fabricate a wound body.

Thereafter, the wound body is contained inside the depression part 20U and the film 20 is folded, following which outer edges of two sides of the film 20 (the fusion-bonding layer) are bonded to each other by a method such as a thermal fusion bonding method. Thus, the wound body is placed into the pouch-shaped film 20. Thereafter, the electrolytic solution is injected into the pouch-shaped film 20, following which the outer edges of the remaining one side of the film 20 (the fusion-bonding layer) are bonded with each other using a method such as a thermal fusion bonding method. In this case, the sealing film 21 is disposed between the film 20 and the positive electrode lead 14, and the sealing film 22 is disposed between the film 20 and the negative electrode lead 15. The wound body is thereby impregnated with the electrolytic solution. Thus, the wound electrode body 10 is fabricated. Accordingly, the wound electrode body 10 is sealed in the pouch-shaped film 20. As a result, the secondary battery is assembled.

Lastly, the secondary battery is charged and discharged in order to stabilize a state of the secondary battery. Various conditions including, for example, an environmental temperature, the number of times of charging and discharging (the number of cycles), and charging and discharging conditions may be set freely. The charging and discharging of the secondary battery cause an SEI film to be formed on a surface, for example, of the negative electrode 12. As a result, the secondary battery of the laminated-film type is completed.

According to the secondary battery of the laminated-film type of an embodiment, the electrolytic solution includes the sulfur-phosphorus-containing compound, and the sulfur-phosphorus-containing compound is a compound that includes both the sulfuric-acid-type group and the phosphoric-acid-type group as represented by Formula (1).

In this case, the sulfur-phosphorus-containing compound reacts preferentially over the solvent upon charging and discharging, and this allows the film derived from the sulfur-phosphorus-containing compound to be formed on a surface of the positive electrode 11. The film derived from the sulfur-phosphorus-containing compound has a property that the electric resistance does not easily increase as compared with a film derived from a compound other than the sulfur-phosphorus-containing compound. Thus, in the secondary battery having the film derived from the sulfur-phosphorus-containing compound formed on the surface of the positive electrode 11, the electric resistance does not easily increase even if the charging and discharging are repeated. Further, the film protects the surface of the positive electrode 11 from the electrolytic solution. Thus, in the secondary battery having the film formed on the surface of the positive electrode 11, the decomposition reaction of the electrolytic solution attributed to reactivity of the positive electrode 11 is prevented from proceeding even if the charging and discharging are repeated. As a result, upon charging and discharging, the decomposition reaction of the electrolytic solution is suppressed by the film while the increase in the electric resistance caused by the presence of the film is suppressed. Therefore, the suppression of the increase in the electric resistance and the suppression of the decomposition reaction of the electrolytic solution are both achievable, which makes it possible to obtain superior battery characteristics.

Note that the compound other than the sulfur-phosphorus-containing compound described above is a compound similar to the sulfur-phosphorus-containing compound, and specific examples thereof include respective compounds represented by Formulae (2-1) to (2-5). The compound represented by Formula (2-1) includes one sulfuric-acid-type group and no phosphoric-acid-type group. The compound represented by Formula (2-2) includes one phosphoric-acid-type group and no sulfuric-acid-type group. The compound represented by Formula (2-3) includes two sulfuric-acid-type groups and no phosphoric-acid-type group. The compound represented by Formula (2-4) includes: one phosphoric-acid-type group; and one carboxylic-acid-type group (H₅C₂O—C(═O)—) instead of one sulfuric-acid-type group. The compound represented by Formula (2-5) includes two phosphoric-acid-type groups and no sulfuric-acid-type group.

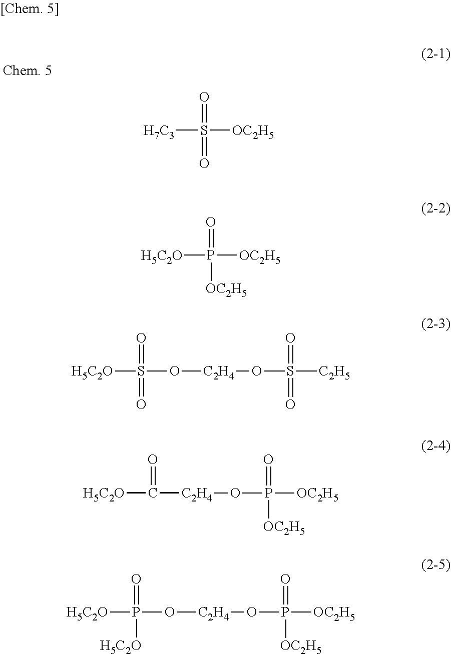

In particular, X in Formula (1) may be the alkylene group. This stably suppresses the decomposition reaction of the electrolytic solution while stably suppressing the increase in the electric resistance, which makes it possible to achieve higher effects according to an embodiment.

In this case, according to an embodiment, the alkylene group may have carbon number from 1 to 3 both inclusive. This further improves, for example, the solubility and the compatibility of the sulfur-phosphorus-containing compound, which allows the film derived from the sulfur-phosphorus-containing compound to be easily formed. Accordingly, it is possible to achieve further higher effects. Moreover, the alkylene group may have carbon number of 2 or 3. This still further improves, for example, the solubility and the compatibility of the sulfur-phosphorus-containing compound, which allows the film derived from the sulfur-phosphorus-containing compound to be more easily formed. Accordingly, it is possible to achieve markedly high effects.

Further, the monovalent hydrocarbon group in Formula (1) may be the alkyl group according to an embodiment. This stably suppresses the decomposition reaction of the electrolytic solution while stably suppressing the increase in the electric resistance, which makes it possible to achieve higher effects.

Further, the monovalent oxygen-containing hydrocarbon group in Formula (1) may be the alkoxy group according to an embodiment. This stably suppresses the decomposition reaction of the electrolytic solution while stably suppressing the increase in the electric resistance, which makes it possible to achieve higher effects.

Further, the content of the sulfur-phosphorus-containing compound in the electrolytic solution may be greater than or equal to 0.01 wt % and less than or equal to 1 wt % according to an embodiment. This sufficiently suppresses the decomposition reaction of the electrolytic solution while sufficiently suppressing the increase in the electric resistance, which makes it possible to achieve higher effects.

Further, the secondary battery may include the lithium-ion secondary battery according to an embodiment. This allows a sufficient battery capacity to be obtained stably by utilizing lithium insertion and extraction, which makes it possible to achieve higher effects.

Next, a description is given of modifications of the above-described secondary battery according to an embodiment. The configuration of the secondary battery is appropriately modifiable as described below. Note that any two or more of the following series of modifications may be combined.

According to an embodiment, the number of positive electrode leads 14 and the number of negative electrode leads 15 are each not particularly limited. In other words, the number of positive electrode leads 14 is not limited to one, and may be two or more, and the number of negative electrode leads 15 is not limited to one, and may be two or more. It is possible to obtained similar effects also in a case where the number of positive electrode leads 14 and the number of negative electrode leads 15 are each changed.

According to an embodiment, the separator 13 which is a porous film is used. However, although not specifically illustrated here, a separator of a stack type including a polymer compound layer may be used instead of the separator 13 which is the porous film.

Specifically, the separator of the stack type includes: a base layer which is the above-described porous film; and a polymer compound layer provided on one side or each of both sides of the base layer. A reason for this is that adherence of the separator to each of the positive electrode 11 and the negative electrode 12 improves to suppress occurrence of positional deviation of the wound electrode body 10. This helps to reduce swelling of the secondary battery, for example, even if the decomposition reaction of the electrolytic solution occurs. The polymer compound layer includes a polymer compound such as polyvinylidene difluoride. A reason for this is that such a polymer compound has superior physical strength and is electrochemically stable according to an embodiment.

Note that the base layer, the polymer compound layer, or both may each include one or more kinds of particles including, for example, inorganic particles and resin particles. A reason for this is that heat is released by the particles when the secondary battery generates heat, which improves heat resistance and safety of the secondary battery according to an embodiment. The inorganic particles are not limited to a particular kind, and examples thereof include aluminum oxide (alumina) particles, aluminum nitride particles, boehmite particles, silicon oxide (silica) particles, titanium oxide (titania) particles, magnesium oxide (magnesia) particles, and zirconium oxide (zirconia) particles.

In a case of fabricating the separator of the stack type, a precursor solution that includes materials including, without limitation, the polymer compound and an organic solvent is prepared, following which the precursor solution is applied on one side or each of both sides of the base layer.

Similar effects are obtainable also in the case where the separator of the stack type is used, as lithium is movable between the positive electrode 11 and the negative electrode 12.

According to an embodiment, the electrolytic solution which is a liquid electrolyte is included. However, although not specifically illustrated here, an electrolyte layer which is a gel electrolyte may be included instead of the electrolytic solution.

In the wound electrode body 10 including the electrolyte layer, the positive electrode 11 and the negative electrode 12 are stacked with the separator 13 and the electrolyte layer interposed therebetween, and the stack of the positive electrode 11, the negative electrode 12, the separator 13, and the electrolyte layer is wound. The electrolyte layer is interposed between the positive electrode 11 and the separator 13, and between the negative electrode 12 and the separator 13.

Specifically, the electrolyte layer includes a polymer compound together with the electrolytic solution. The electrolytic solution is held by the polymer compound in the electrolyte layer. The configuration of the electrolytic solution is as described above. The polymer compound includes, for example, polyvinylidene difluoride. In a case of forming the electrolyte layer, a precursor solution that includes materials including, without limitation, the electrolytic solution, the polymer compound, and an organic solvent is prepared, following which the precursor solution is applied on one side or each of both sides of each of the positive electrode 11 and the negative electrode 12.

Similar effects are obtainable also in the case of including the electrolyte layer, as lithium is movable between the positive electrode 11 and the negative electrode 12 via the electrolyte layer.

Next, a description is given of applications (application examples) of the above-described secondary battery according to an embodiment.

The applications of the secondary battery are not particularly limited and can include, for example, machines, apparatuses, instruments, devices, or systems (an assembly of, for example, a plurality of apparatuses) in which the secondary battery is usable mainly as a driving power source, an electric power storage source for electric power accumulation, or any other source. The secondary battery used as a power source may serve as a main power source or an auxiliary power source. The main power source is preferentially used regardless of the presence of any other power source. The auxiliary power source may be used in place of the main power source, or may be switched from the main power source on an as-needed basis. In a case where the secondary battery is used as the auxiliary power source, the kind of the main power source is not limited to the secondary battery.

Specific examples of the applications of the secondary battery include electronic apparatuses including portable electronic apparatuses; portable life appliances; storage devices; electric power tools; battery packs mountable on laptop personal computers or other apparatuses as a detachable power source; medical electronic apparatuses; electric vehicles; and electric power storage systems. Examples of the electronic apparatuses include video cameras, digital still cameras, mobile phones, laptop personal computers, cordless phones, headphone stereos, portable radios, portable televisions, and portable information terminals. Examples of the portable life appliances include electric shavers. Examples of the storage devices include backup power sources and memory cards. Examples of the electric power tools include electric drills and electric saws. Examples of the medical electronic apparatuses include pacemakers and hearing aids. Examples of the electric vehicles include electric automobiles including hybrid automobiles. Examples of the electric power storage systems include home battery systems for accumulation of electric power for emergency, for example. Note that a structure of the secondary battery may be the above-described laminated-film type or a cylindrical type, or may be any other type. Further, multiple secondary batteries may be used as, for example, a battery pack and a battery module.

According to an embodiment, the battery pack and the battery module are each effectively applied to a relatively large-sized apparatus such as an electric vehicle, an electric power storage system, or an electric power tool. The battery pack, as will be described later, may include a single battery, or may include an assembled battery. The electric vehicle is a vehicle that operates (travels) using the secondary battery as a driving power source, and may be an automobile (such as a hybrid automobile) additionally provided with a driving source other than the secondary battery as described above. The electric power storage system is a system that uses the secondary battery as an electric power storage source. An electric power storage system for home use accumulates electric power in the secondary battery which is an electric power storage source, and therefore, the accumulated electric power may be utilized for using, for example, home electric appliances.

Some application examples of the secondary battery will now be described in detail according to an embodiment. The configurations of the application examples described below are each merely an example, and are appropriately modifiable. The type of the secondary battery used in the following application examples is not particularly limited, and may be a laminated-film type or a cylindrical type.

FIG. 3 illustrates a block configuration of a battery pack including a single battery according to an embodiment. The battery pack described here is a simple battery pack (a so-called soft pack) including one secondary battery, and is mounted on, for example, an electronic apparatus as typified by a smartphone.

As illustrated in FIG. 3, the battery pack includes an electric power source 61 and a circuit board 62. The circuit board 62 is coupled to the electric power source 61, and includes a positive electrode terminal 63, a negative electrode terminal 64, and a temperature detection terminal (a so-called T terminal) 65.

The electric power source 61 includes one secondary battery. The secondary battery has a positive electrode lead coupled to the positive electrode terminal 63 and a negative electrode lead coupled to the negative electrode terminal 64. The electric power source 61 is able to be coupled to outside through the positive electrode terminal 63 and the negative electrode terminal 64, and is thus able to be charged and discharged through the positive electrode terminal 63 and the negative electrode terminal 64. The circuit board 62 includes a controller 66, a switch 67, a PTC device 68, and a temperature detector 69. However, the PTC device 68 may be omitted.

The controller 66 includes, for example, a central processing unit (CPU) and a memory, and controls an overall operation of the battery pack. The controller 66 detects and controls a use state of the electric power source 61 as necessary.

When a battery voltage of the electric power source 61 (the secondary battery) reaches an overcharge detection voltage or an overdischarge detection voltage, the controller 66 turns off the switch 67. This prevents a charging current from flowing in a current path of the electric power source 61. In addition, when a large current flows during charging or discharging, the controller 66 turns off the switch 67 to block the charging current. The overcharge detection voltage and the overdischarge detection voltage are not particularly limited. For example, the overcharge detection voltage is 4.2 V±0.05 V and the overdischarge detection voltage is 2.4 V±0.1 V.

The switch 67 includes, for example, a charge control switch, a discharge control switch, a charge diode, and a discharge diode. The switch 67 performs switching between connection and disconnection of the electric power source 61 and an external apparatus in accordance with an instruction from the controller 66. The switch 67 includes, for example, a metal-oxide-semiconductor field-effect transistor (MOSFET) including a metal-oxide semiconductor. The charging/discharging current is detected on the basis of an ON-resistance of the switch 67.

The temperature detector 69 includes a temperature detection device such as a thermistor. The temperature detector 69 measures a temperature of the electric power source 61 using the temperature detection terminal 65, and outputs a result of the temperature measurement to the controller 66. The result of the temperature measurement to be obtained by the temperature detector 69 is used, for example, in a case where the controller 66 performs charging/discharging control upon occurrence of abnormal heat generation or in a case where the controller 66 performs a correction process upon calculating a remaining capacity.

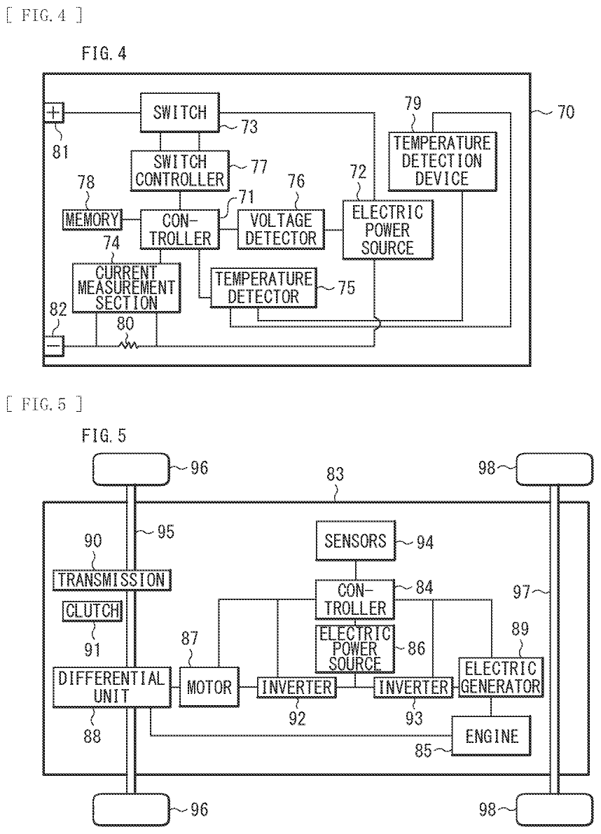

FIG. 4 illustrates a block configuration of a battery pack including an assembled battery according to an embodiment. In the following description, reference will be made as necessary to the components of the battery pack including the single battery (see FIG. 3).

As illustrated in FIG. 4, the battery pack includes a positive electrode terminal 81 and a negative electrode terminal 82. Specifically, inside a housing 70, the battery pack includes a controller 71, an electric power source 72, a switch 73, a current measurement section 74, a temperature detector 75, a voltage detector 76, a switch controller 77, a memory 78, a temperature detection device 79, and a current detection resistor 80.

The electric power source 72 includes an assembled battery in which two or more secondary batteries are coupled to each other, and a type of connection of the two or more secondary batteries is not particularly limited. Accordingly, the connection scheme may be in series, may be in parallel, or may be a mixed type of both. For example, the electric power source 72 includes six secondary batteries coupled to each other in two parallel and three series.

Configurations of the controller 71, the switch 73, the temperature detector 75, and the temperature detection device 79 are similar to those of the controller 66, the switch 67, and the temperature detector 69 (the temperature detection device). The current measurement section 74 measures a current using the current detection resistor 80, and outputs a result obtained by measuring the current to the controller 71. The voltage detector 76 measures a battery voltage of the electric power source 72 (the secondary battery) and provides the controller 71 with a result obtained by measuring the voltage that has been subjected to analog-to-digital conversion.

The switch controller 77 controls an operation of the switch 73 in response to signals supplied by the current measurement section 74 and the voltage detector 76. When a battery voltage reaches an overcharge detection voltage or an overdischarge detection voltage, the switch controller 77 turns off the switch 73 (the charge control switch). This prevents a charging current from flowing in a current path of the electric power source 72. This enables the electric power source 72 to perform only discharging through the discharging diode, or only charging through the charging diode. In addition, when a large current flows during charging or discharging, the switch controller 77 blocks the charging current or a discharging current.

The switch controller 77 may be omitted, thereby causing the controller 71 to also operate as the switch controller 77. The overcharge detection voltage and the overdischarge detection voltage are not particularly limited, and are similar to those described above in relation to the battery pack including the single battery.

The memory 78 includes, for example, an electrically erasable programmable read-only memory (EEPROM) which is a non-volatile memory, and the memory 78 stores, for example, numeric values calculated by the controller 71 and information (e.g., an initial internal resistance, a full charge capacity, and a remaining capacity) of the secondary battery measured in the manufacturing process.

The positive electrode terminal 81 and the negative electrode terminal 82 are terminals coupled to, for example, an external apparatus (e.g., a laptop personal computer) which operates using the battery pack, or an external apparatus (e.g., a charger) which is used to charge the battery pack. The electric power source 72 (secondary battery) is able to be charged and discharged through the positive electrode terminal 81 and the negative electrode terminal 82.

FIG. 5 illustrates a block configuration of a hybrid automobile which is an example of the electric vehicle according to an embodiment. As illustrated in FIG. 5, inside a housing 83, the electric vehicle includes a controller 84, an engine 85, an electric power source 86, a motor 87, a differential unit 88, an electric generator 89, a transmission 90, a clutch 91, inverters 92 and 93, and sensors 94. The electric vehicle also includes: a front wheel drive shaft 95 and a pair of front wheels 96 that are coupled to the differential unit 88 and the transmission 90; and a rear wheel drive shaft 97 and a pair of rear wheels 98.

The electric vehicle is configured to travel by using one of the engine 85 and the motor 87 as a driving source. The engine 85 is a major power source, such as a gasoline engine. In a case where the engine 85 is used as a power source, a driving force (a rotational force) of the engine 85 is transmitted to the front wheels 96 and the rear wheels 98 via the differential unit 88, the transmission 90, and the clutch 91, which are driving parts. Note that the rotational force of the engine 85 is transmitted to the electric generator 89, thereby causing the electric generator 89 to generate alternating-current power by utilizing the rotational force and also causing the alternating-current power to be converted into direct-current power via the inverter 93. Thus, the direct-current power is accumulated in the electric power source 86. In contrast, in a case where the motor 87 which is a converter is used as a power source, the power (direct-current power) supplied from the electric power source 86 is converted into the alternating-current power via the inverter 92. Thus, the motor 87 is driven by utilizing the alternating-current power. The driving force (the rotational force) converted from the electric power by the motor 87 is transmitted to the front wheels 96 and the rear wheels 98 through the differential unit 88, the transmission 90, and the clutch 91, which are the driving parts.

When the electric vehicle is decelerated via a brake mechanism, the resistance force at the time of deceleration is transmitted as the rotational force to the motor 87. Thus, the motor 87 may generate the alternating-current power by utilizing the rotational force. The alternating-current power is converted into the direct-current power via the inverter 92, and direct-current regenerative power is accumulated in the electric power source 86.

The controller 84 includes, for example, a CPU, and controls an overall operation of the electric vehicle. The electric power source 86 includes one or more secondary batteries and is coupled to an external electric power source. In this case, the electric power source 86 may accumulate electric power by being supplied with electric power from the external electric power source. The sensors 94 are used to control the number of revolutions of the engine 85 and to control an angle of a throttle valve (a throttle angle). The sensors 94 include one or more of sensors including, without limitation, a speed sensor, an acceleration sensor, and an engine speed sensor.

The case where the electric vehicle is a hybrid automobile is described as an example; however, the electric vehicle may be a vehicle (an electric vehicle) that operates using only the electric power source 86 and the motor 87 and not using the engine 85.

Although not specifically illustrated here, other application examples of the secondary battery are also conceivable.

According to an embodiment, the secondary battery is applicable to an electric power storage system. The electric power storage system includes, inside a building such as a residential house or a commercial building: a controller; an electric power source including one or more secondary batteries; a smart meter; and a power hub.

The electric power source is coupled to an electric apparatus such as a refrigerator installed inside the building, and is able to be coupled to an electric vehicle such as a hybrid automobile stopped outside the building. Further, the electric power source is coupled, via the power hub, to a home power generator such as a solar power generator installed at the building, and is also coupled, via the smart meter and the power hub, to a centralized power system of an external power station such as a thermal power station.

Alternatively, the secondary battery is applicable to an electric power tool such as an electric drill or an electric saw according to an embodiment. The electric power tool includes, inside a housing to which a movable part such as a drilling part or a saw blade part is attached: a controller; and an electric power source including one or more secondary batteries.

### EXAMPLES

A description is given of Examples of the technology below according to an embodiment.

### Experiment Examples 1-1 to 1-18

Secondary batteries (lithium-ion secondary batteries) of the laminated-film type illustrated in FIGS. 1 and 2 were fabricated, following which a battery characteristic of the secondary batteries was evaluated as described below.

### [Fabrication of Secondary Battery]

The secondary batteries were fabricated in accordance with the following procedure according to an embodiment.

### (Fabrication of Positive Electrode)

First, 91 parts by mass of the positive electrode active material (lithium cobalt oxide (LiCoO₂)), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into an organic solvent (N-methyl-2-pyrrolidone), following which the organic solvent was stirred to thereby prepare a paste positive electrode mixture slurry. Thereafter, the positive electrode mixture slurry was applied on both sides of the positive electrode current collector 11A (a band-shaped aluminum foil having a thickness of 12 μm) by means of a coating apparatus, following which the applied positive electrode mixture slurry was dried to thereby form the positive electrode active material layers 11B. Lastly, the positive electrode active material layers 11B were compression-molded by means of a roll pressing machine. Thus, the positive electrode active material layer 11B was formed on each of both sides of the positive electrode current collector 11A, thereby fabricating the positive electrode 11.

### (Fabrication of Negative Electrode)

First, 93 parts by mass of the negative electrode active material (artificial graphite serving as a carbon material) and 7 parts by mass of the negative electrode binder (polyvinylidene difluoride) were mixed with each other to thereby obtain a negative electrode mixture. Thereafter, the negative electrode mixture was put into an organic solvent (N-methyl-2-pyrrolidone), following which the organic solvent was stirred to thereby prepare a paste negative electrode mixture slurry. Thereafter, the negative electrode mixture slurry was applied on both sides of the negative electrode current collector 12A (a band-shaped copper foil having a thickness of 15 μm) by means of a coating apparatus, following which the applied negative electrode mixture slurry was dried to thereby form the negative electrode active material layers 12B. Lastly, the negative electrode active material layers 12B were compression-molded by means of a roll pressing machine. Thus, the negative electrode active material layer 12B was formed on each of both sides of the negative electrode current collector 12A, thereby fabricating the negative electrode 12.

### (Preparation of Electrolytic Solution)

First, the solvent was prepared. Used as the solvent were ethylene carbonate (EC) serving as the carbonic-acid-ester-based compound (the cyclic carbonic acid ester), diethyl carbonate (DEC) serving as the carbonic-acid-ester-based compound (the chain carbonic acid ester), and propyl propionate (PP) serving as the carboxylic-acid-ester-based compound. A mixture ratio (a weight ratio) between EC, DEC, and PP in the solvent was set to 30:30:40.

Thereafter, the electrolyte salt (lithium hexafluorophosphate (LiPF₆)) was added to the solvent, following which the solvent was stirred. The content of the electrolyte salt was set to 1 mol/l (=1 mol/dm³) kg with respect to the solvent.

Lastly, the sulfur-phosphorus-containing compound and vinylene carbonate serving as the unsaturated cyclic carbonic acid ester were added to the solvent, following which the solvent was stirred. Used as the sulfur-phosphorus-containing compound was a compound in which X in Formula (1) is the alkylene group. Kinds of the sulfur-phosphorus-containing compounds were as described in Table 1. A column of “carbon number” in Table 1 describes the carbon number of X (the alkylene group). A content of the unsaturated cyclic carbonic acid ester in the electrolytic solution was set to 1 wt %. Thus, the electrolyte salt and the sulfur-phosphorus-containing compound were each dispersed or dissolved into the solvent, thereby preparing the electrolytic solution.

For comparison, the electrolytic solution was prepared in accordance with a similar procedure except that the sulfur-phosphorus-containing compound was not used. Further, for comparison, the electrolytic solution was prepared in accordance with a similar procedure except that each of other compounds was used instead of the sulfur-phosphorus-containing compound. Kinds of the other compounds were as described in Table 1.

### (Assembly of Secondary Battery)

First, the positive electrode lead 14 including aluminum was welded to the positive electrode current collector 11A, and the negative electrode lead 15 including copper was welded to the negative electrode current collector 12A. Thereafter, the positive electrode 11 and the negative electrode 12 were stacked on each other with the separator 13 (a fine-porous polyethylene film having a thickness of 15 μm) interposed therebetween, following which the stack of the positive electrode 11, the negative electrode 12, and the separator 13 was wound, to thereby fabricate a wound body.

Thereafter, the film 20 was folded in such a manner as to sandwich the wound body contained in the depression part 20U, following which the outer edges of two sides of the film 20 were thermal fusion bonded to each other. Thus, the wound body was placed into the pouch-shaped film 20. As the film 20, an aluminum laminated film was used in which a fusion-bonding layer (a polypropylene film having a thickness of 30 pin), a metal layer (an aluminum foil having a thickness of 40 μm), and a surface protective layer (a nylon film having a thickness of 25 μm) were stacked in this order from an inner side.

Thereafter, the electrolytic solution was injected into the pouch-shaped film 20, following which the outer edges of the one remaining side of the film 20 were thermal fusion bonded to each other in a reduced-pressure environment. In this case, the sealing film 21 (a polypropylene film having a thickness of 5 μm) was interposed between the film 20 and the positive electrode lead 14, and the sealing film 22 (a polypropylene film having a thickness of 5 μm) was interposed between the film 20 and the negative electrode lead 15. Accordingly, the wound body was impregnated with the electrolytic solution, thereby forming the wound electrode body 10. Thus, the wound electrode body 10 was sealed in the film 20. As a result, the secondary battery was assembled.

Lastly, the secondary battery was charged and discharged for one cycle in an ambient temperature environment at a temperature of 23° C. in order to stabilize a state of the secondary battery. Charging and discharging conditions were similar to those for a case of examining an electric resistance characteristic to be described later. The charging and discharging of the secondary battery caused an SEI film to be formed on the surface of, for example, the negative electrode 12. Thus, the secondary battery of the laminated-film type was completed. The contents (wt %) of the sulfur-phosphorus-containing compound in the electrolytic solution after the stabilization of the state of the secondary battery (after the formation of the SEI film) were as described in Table 1.

### [Evaluation of Battery Characteristic]

Evaluation of a battery characteristic (an electric resistance characteristic) of the secondary batteries revealed the results described in Table 1 according to an embodiment.

In a case of examining the electric resistance characteristic, the secondary battery was charged and discharged for 100 cycles in a high-temperature environment at a temperature of 45° C., following which the electric resistance (mΩ) of the secondary battery was measured using a battery tester.

Upon charging, the secondary battery was charged with a constant current of 0.1 C until a voltage reached 4.2 V, and was thereafter charged with a constant voltage of 4.2 V until a current reached 0.05 C. Upon discharging, the secondary battery was discharged with a constant current of 0.1 C until the voltage reached 3.0 V. Note that 0.1 C is a value of a current that causes a battery capacity (a theoretical capacity) to be completely discharged in 10 hours, and 0.05 C is a value of a current that causes the battery capacity to be completely discharged in 20 hours.

TABLE 1

| | Electrolytic solution | | | | |
|---|---|---|---|---|---|
| | Sulfur- | | | | |
| | phosphorus- | | | | Electric |
| Experiment | containing | Carbon | Other | Content | resistance |
| example | compound | number | compound | (wt %) | (mΩ) |
| 1-1 | Formula (1-1) | 2 | — | 0.01 | 45 |
| 1-2 | Formula (1-2) | 3 | — | 0.01 | 46 |
| 1-3 | Formula (1-3) | 2 | — | 0.001 | 53 |
| 1-4 | | | | 0.01 | 43 |
| 1-5 | | | | 0.1 | 45 |
| 1-6 | | | | 1 | 47 |
| 1-7 | | | | 3 | 54 |
| 1-8 | Formula (1-4) | 3 | — | 0.01 | 46 |
| 1-9 | Formula (1-5) | 2 | — | 0.01 | 44 |
| 1-10 | Formula (1-6) | 2 | — | 0.01 | 46 |
| 1-11 | Formula (1-7) | 1 | — | 0.01 | 56 |
| 1-12 | Formula | 4 | — | 0.01 | 58 |
| | (1-28) | | | | |
| 1-13 | — | — | — | — | 72 |
| 1-14 | — | — | Formula (2-1) | 0.01 | 69 |
| 1-15 | — | — | Formula (2-2) | 0.01 | 71 |
| 1-16 | — | — | Formula (2-3) | 0.01 | 69 |
| 1-17 | — | — | Formula (2-4) | 0.01 | 68 |
| 1-18 | — | — | Formula (2-5) | 0.01 | 72 |

As described in Table 1, the battery characteristic (the electric resistance characteristic) of the secondary battery varied greatly depending on the configuration of the electrolytic solution. In the following, the electric resistance of a case where the electrolytic solution included neither sulfur-phosphorus-containing compound nor other compound (Experiment example 1-13) was used as a comparison reference.

Specifically, in each of cases where the electrolytic solution included other compounds (Experiment examples 1-14 to 1-18), the electric resistance was approximately equal to the comparison reference; thus, the electric resistance remained to be high.

In contrast, in each of cases where the electrolytic solution included the sulfur-phosphorus-containing compound (Experiment examples 1-1 to 1-12), the electric resistance decreased greatly.

In particular, the following tendencies were obtained in each of the secondary batteries in which the electrolytic solution included the sulfur-phosphorus-containing compound. First, in each of cases where the carbon number of X (the alkylene group) was from 1 to 3 both inclusive (Experiment examples 1-1, 1-2, and 1-11), the electric resistance further decreased as compared with a case where the carbon number of X was 4 (Experiment example 1-12). Second, in each of cases where the carbon number of X is 2 or 3 (Experiment examples 1-1 and 1-2), the electric resistance still further decreased as compared with the case where the carbon number of X was 1 (Experiment example 1-11). Third, in a case where the content of the sulfur-phosphorus-containing compound in the electrolytic solution was from 0.01 wt % to 1 wt % both inclusive, the electric resistance further decreased.

### Experiment Examples 2-1 and 2-2

As described in Table 2, secondary batteries were fabricated and the battery characteristic was evaluated by similar procedures except that the configuration of the electrolytic solution (the solvent) was changed. In this case, ethyl propionate (EP) was used instead of propyl propionate, as the carboxylic-acid-ester-based compound according to an embodiment.

TABLE 2

| | Electrolytic solution | | | | | |
|---|---|---|---|---|---|---|
| | | Mixture | Sulfur- | | | |
| | | ratio | phosphorus - | | | Electric |
| Experiment | | (weight | containing | Other | Content | resistance |
| example | Solvent | ratio) | compound | compound | (wt %) | (mΩ) |
| 1-4 | EC + DEC + PP | 30:30:40 | Formula (1-3) | — | 0.01 | 43 |
| 1-13 | | | — | — | — | 72 |
| 1-14 | | | — | Formula (2-1) | 0.01 | 69 |
| 2-1 | EC + DEC + EP | 30:30:40 | Formula (1-3) | — | 0.01 | 39 |
| 2-2 | | | — | Formula (2-1) | 0.01 | 65 |

As described in Table 2, even if the configuration of the solvent was changed, the electric resistance decreased greatly in a case where the electrolytic solution included the sulfur-phosphorus-containing compound (Experiment example 2-1), unlike a case where the electrolytic solution included the other compound (Experiment example 2-2).

Based upon the results described in Tables 1 and 2, in the case where the electrolytic solution included the sulfur-phosphorus-containing compound, the electric resistance characteristic of the secondary battery improved. Accordingly, a superior battery characteristic of the secondary battery was obtained.

Although the technology has been described above with reference to the embodiments and Examples, configurations of the technology are not limited to those described with reference to the embodiments and Examples above and are modifiable in a variety of ways.

While the description has been given of the case where the structure of the secondary battery is of the laminated-film type, the structure is not particularly limited. Accordingly, the second battery may have other structures including, without limitation, those of a cylindrical type, a prismatic type, a coin type, and a button type.

Moreover, although the description has been given of a case of the battery device having a wound structure, the structure of the battery device is not particularly limited. Accordingly, the battery device may have a structure such as that of a stacked type in which electrodes (a positive electrode and a negative electrode) are stacked on each other or a zigzag folded type in which the electrodes (the positive electrode and the negative electrode) are folded in a zigzag manner.

Further, although the description has been given of a case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

Note that the effects described herein are mere examples, and effects of the technology are therefore not limited to those described herein. Accordingly, the technology may achieve any other effect.

It should be understood that various changes and modifications to the presently preferred embodiments described herein will be apparent to those skilled in the art. Such changes and modifications can be made without departing from the spirit and scope of the present subject matter and without diminishing its intended advantage. It is therefore intended that such changes and modifications be covered by the appended claims.

1. A secondary battery comprising:
a positive electrode;
a negative electrode; and
an electrolytic solution including a sulfur-phosphorus-containing compound represented by Formula (1), 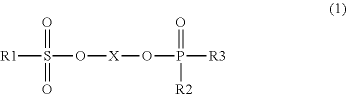
where
each of R1, R2, and R3 is one of a monovalent hydrocarbon group, a monovalent oxygen-containing hydrocarbon group, a monovalent halogenated hydrocarbon group, a monovalent halogenated oxygen-containing hydrocarbon group, and a halogen group, and
X is one of a divalent hydrocarbon group and a divalent halogenated hydrocarbon group.

2. The secondary battery according to claim 1, wherein X is an alkylene group.

3. The secondary battery according to claim 2, wherein the alkylene group has a carbon number from 1 to 3 both inclusive.

4. The secondary battery according to claim 3, wherein the carbon number of the alkylene group is 2 or 3.

5. The secondary battery according to claim 1, wherein the monovalent hydrocarbon group is an alkyl group.

6. The secondary battery according to claim 1, wherein the monovalent oxygen-containing hydrocarbon group is an alkoxy group.

7. The secondary battery according to claim 1, wherein a content of the sulfur-phosphorus-containing compound in the electrolytic solution is greater than or equal to 0.01 weight percent and less than or equal to 1 weight percent.

8. The secondary battery according to claim 1, wherein the secondary battery comprises a lithium-ion secondary battery.

9. An electrolytic solution for a secondary battery, the electrolytic solution comprising a sulfur-phosphorus-containing compound represented by Formula (1), 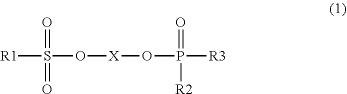
where
each of R1, R2, and R3 is one of a monovalent hydrocarbon group, a monovalent oxygen-containing hydrocarbon group, a monovalent halogenated hydrocarbon group, a monovalent halogenated oxygen-containing hydrocarbon group, and a halogen group, and
X is one of a divalent hydrocarbon group and a divalent halogenated hydrocarbon group.

10. The electrolytic solution according to claim 9, wherein X is an alkylene group.

11. The electrolytic solution according to claim 10, wherein the alkylene group has a carbon number from 1 to 3 both inclusive.

12. The electrolytic solution according to claim 11, wherein the carbon number of the alkylene group is 2 or 3.

13. The electrolytic solution according to claim 9, wherein the monovalent hydrocarbon group is an alkyl group.

14. The electrolytic solution according to claim 9, wherein the monovalent oxygen-containing hydrocarbon group is an alkoxy group.

15. The electrolytic solution according to claim 9, wherein a content of the sulfur-phosphorus-containing compound in the electrolytic solution is greater than or equal to 0.01 weight percent and less than or equal to 1 weight percent.

16. The electrolytic solution according to claim 9, wherein the secondary battery comprises a lithium-ion secondary battery.
